(19) United States
(12) Patent Application Publication
(10) Pub. No.: US 2017/0321875 A1
(43) Pub. Date: Nov. 9, 2017

(54) LED LIGHTING FIXTURE AND HEAT SINK THEREFOR

(71) Applicants: Edwin Rambusch, Jersey City, NJ (US); Jim Hasler, Jersey City, NJ (US)

(72) Inventors: Edwin Rambusch, Jersey City, NJ (US); Jim Hasler, Jersey City, NJ (US)

(21) Appl. No.: 15/660,212

(22) Filed: Jul. 26, 2017

Related U.S. Application Data
(63) Continuation-in-part of application No. 14/747,082, filed on Jun. 23, 2015, now abandoned.
(60) Provisional application No. 62/015,824, filed on Jun. 23, 2014.

(51) Int. Cl. F21V 29/89; F21S 8/02; F21Y 2115/10; F21V 23/00; F21V 29/76

(52) U.S. Cl. CPC F21V 29/89; F21V 23/008; F21V 29/763; F21Y 2115/10; F21S 8/026

(57) ABSTRACT

A lighting fixture includes a light emitting assembly that has a metal plate with opposite first and second surfaces, an LED mounted to the first surface of the metal plate and a foamed metal mounted to the second surface of the metal plate. The light emitting assembly is mounted in a housing that has a rear wall, a plurality of sidewalls projecting from the rear wall and an open front. The foamed metal faces the rear wall of the housing at a position spaced from the rear wall and the LED faces out from the open front of the housing. Openings are provided between the sidewalls of the housing and the light emitting assembly to accommodate a flow of cooling air between the light emitting assembly and the sidewalls and the rear wall of the housing.

This application is a continuation-in-part of application Ser. No. 14/747,082, filed on Jun. 23, 2015, which in turn claims priority on U.S. Provisional Application No. 62/015,824 filed on Jun. 23, 2014.

### BACKGROUND OF THE INVENTION

### 1. Field of the Invention

The invention relates to an LED lighting fixture and a heat sink for an LED lighting fixture.

### 2. Description of the Related Art

A light emitting diode (LED) can provide a bright high quality light with a relatively low power input and with a long service life, as compared to conventional incandescent lights. LEDs also are much smaller than conventional incandescent lights, and hence potentially can give lighting designers more options for designing an aesthetically attractive highly functional lighting fixture. However, LEDs generate large amounts of heat in a relatively small space. The heat can adversely affect the service life of the LED. The heat generated by an LED lighting system or module must be dissipated for safety reasons and for UL approval. Metal heatsinks typically are used to draw heat away from the LED and to dissipate the heat into the ambient surroundings. The typical metal heatsink has an array of metal fins that radiate out from the LED. The fins provide a large surface area of contact between the heatsink and the ambient air so that he can be dissipated efficiently into the air. The things typically define curves to further increase the surface area. These complex heatsink structures normally are produced by molding or extruding. The molds are complex and costly and are not redesigned easily to accommodate differences between one lighting fixture and another.

LEDs have received considerable commercial acceptance in environments where a relatively low level of lumens is sufficient. More particularly, an LED that produces a relatively low level of lumens will produce easily manageable levels of heat and small structures for dissipating the heat can be provided easily.

Large public spaces, such as cathedrals, auditoriums, theaters, train stations and arenas, provide challenges to the designers of lighting fixtures. In this regard, the lighting fixture must provide sufficient light to a large area and also should be aesthetically attractive to the viewing public. All lighting fixtures must be serviced periodically, and the design and placement of lighting fixtures should anticipate the need for periodic access to the lighting fixture for service. The significantly longer service life for an LED makes the LED a desirable option for a large public space. Additionally, the lower power demands for an LED can result in significant savings for illuminating a large public space. However, heat dissipation requirements have complicated efforts to use LED lighting modules or fixtures to illuminate a large public space. In this regard, a metal heatsink for an LED lighting fixture that is sufficiently bright to illuminate a large public space can be expected to weigh 25 pounds or more. This additional weight can significantly complicate efforts to design an aesthetically attractive lighting fixture and to suspend the lighting fixture from a high ceiling.

An object of the subject invention is to provide a heatsink that can efficiently dissipate heat from a large LED lighting fixture without adversely affecting the weight of the fixture.

A further object of the invention is to provide a lightweight LED lighting fixture that can efficiently dissipate heat.

Another object of the invention is to provide an LED module with a heatsink that can be incorporated into an existing lighting fixture as a replacement for a less efficient incandescent light.

### SUMMARY OF THE INVENTION

The invention relates to a heat sink for an LED lighting fixture or LED module. The heatsink is formed at least partly from a foamed metal, such as foamed aluminum, a foamed aluminum alloy or foamed copper. The foamed metal provides a very substantial weight reduction when compared to conventional solid metal heatsinks that are molded or extruded. However, the foamed metal heatsink provides sufficient heat dissipation for an LED lighting fixture even when the LED lighting fixture generates sufficient lumens to light a large space, such as a cathedral, auditorium or theater.

The heatsink may comprise a plurality of foamed metal plates that are supported in one or more arrays of substantially parallel plates. Curved or helically generated fins are not required.

The heatsink may further include a base plate on which the foamed metal plate is supported.

One or more LEDs may be mounted to a surface of the base plate opposite the foamed metal plate. Reflectors may be mounted to the sides of the LED modules opposite the baseplate of the heatsink to direct the light in an appropriate manner for the desired illumination effect.

The LED, the baseplate and the foamed metal plate form a light emitting assembly that can be mounted in a housing. The housing in one embodiment has a rear wall, a side wall enclosure projecting from the rear wall and an open front. The light emitting assembly is mounted in the housing so that the LED is aligned with or near the open front of the housing and is oriented to emit light away from the housing. The light emitting assembly also is mounted so that in the foamed metal plate faces the rear wall of the housing had a position spaced forward from the rear wall. Additionally, the housing and the light emitting assembly are dimensioned so that spaces are formed between the light emitting assembly and the sidewalls of the housing. The spaces between the light emitting assembly and the sidewalls of the housing cooperate with the space between the foamed metal plate and the rear wall of the housing to accommodate a flow of cooling air through the housing for maintaining a desired operating temperature of the LED. Areas of the sidewalls of the housing that have the openings may be sloped to flare away from one another at positions farther from the rear wall of the housing. This sloped orientation facilitates a flow of cooling air into and from the housing. One of the openings may be disposed at a gravitational low point, while another of the openings may be disposed at a gravitational high point. This orientation of the housing can permit an efficient flow of heated air up and away from the housing.

The heatsinks and the LEDs can be part of a module that can be retrofitted into an existing lighting fixture. This option is particularly important for older buildings where the aesthetic and cultural appeal of the existing lighting fixture is important.

### BRIEF DESCRIPTION OF THE DRAWINGS

FIG. 1 is an exploded perspective view of a lighting fixture in accordance with an embodiment of the invention.

FIG. 2 is a perspective view of the assembled lighting fixture of FIG. 1 including a driver box.

FIG. 3 is a side elevation of view of the assembled lighting fixture of FIG. L.

FIG. 4 is a top plan view of the lighting fixture.

FIG. 5 is a bottom plan view of the lighting fixture.

FIG. 6 is a perspective view of an alternate heatsink in accordance with the invention.

FIG. 7 is a side elevational view of the heat sink shown in FIG. 6.

FIG. 8 is a front elevational view of another embodiment of a lighting fixture in accordance with an embodiment of the invention.

FIG. 9 is a cross-sectional view taken along line 9-9 of FIG. 8.

### DETAILED DESCRIPTION

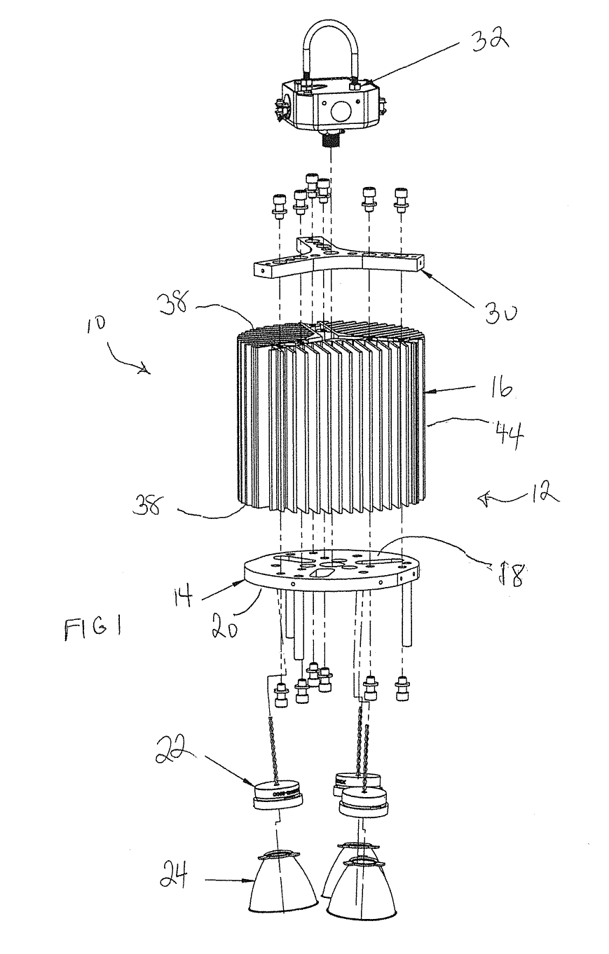

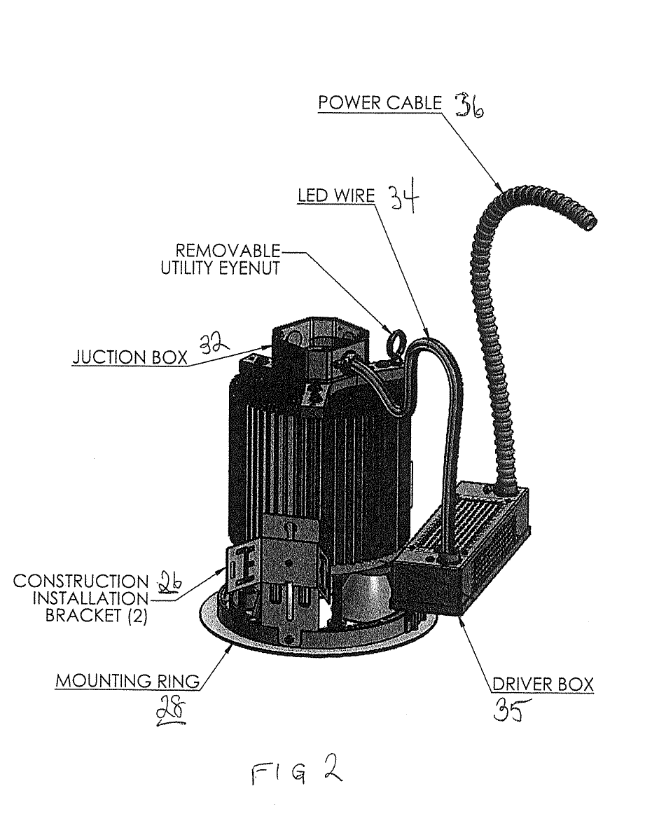

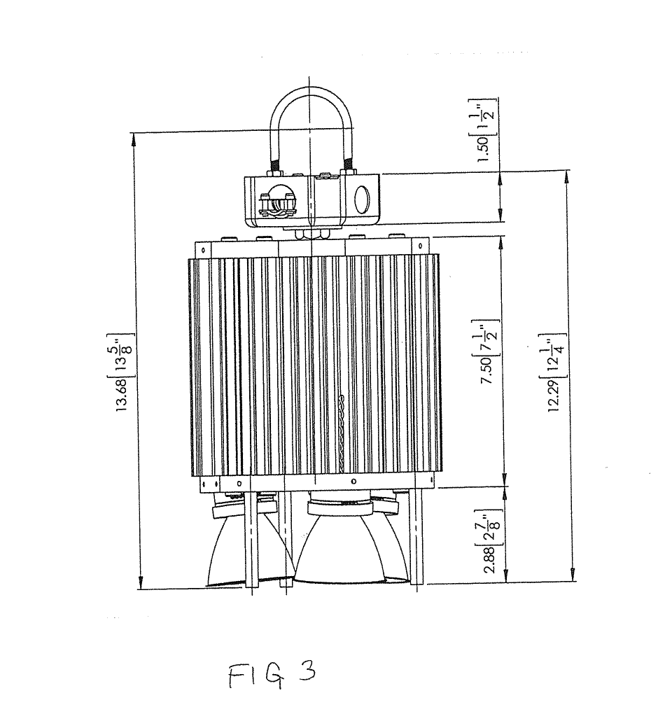

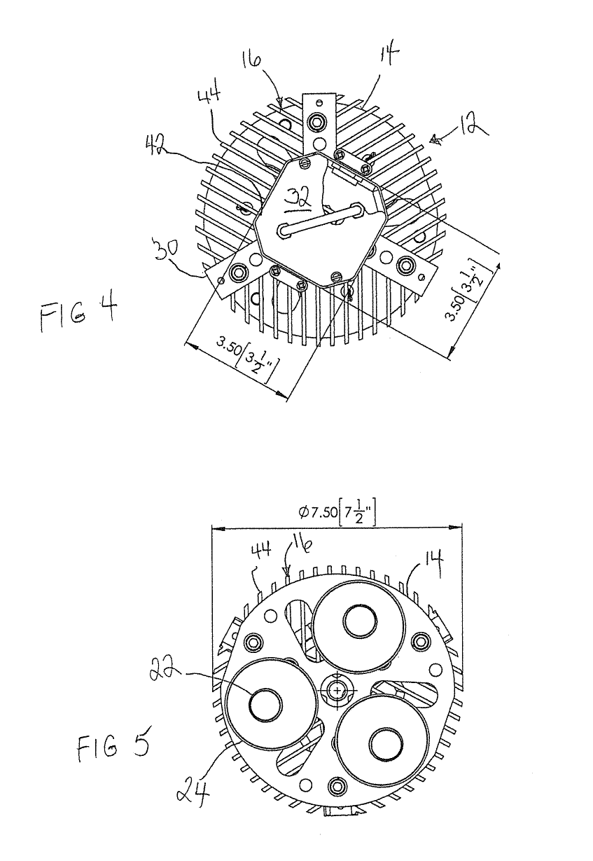

A lighting fixture in accordance with the invention is identified generally by the 10 in FIGS. 1-5. The lighting fixture 10 includes a heat sink 12 formed from a heatsink base 14 and an array of foamed metal plates 16. The heatsink base 14 is substantially circular and has a top surface 18 and a bottom surface 20. LED fixtures 22 are mounted to the bottom surface 20 of the heatsink base 14. Three LED fixtures 22 are provided in the illustrated embodiment. However, other arrangements of the LED fixtures 22 can be provided in other embodiments. In the illustrated embodiment, each LED fixture 22 is capable of generating 3000 lumens, so that a total of 9000 lumens can be generated by the lighting fixture 10. Reflectors 24 are mounted to the sides of the LED fixtures 22 opposite the heatsink base 14. The reflectors 24 function to reflect the light from the LED fixtures 22 toward an area that requires illumination and can take many different forms depending upon the desired lighting effect. An installation bracket 26 may be secured to the heatsink base 14, as shown in FIG. 2, to enable the lighting fixture to be secured to an appropriate supporting structure in a building. A mounting ring 28 may be mounted to the installation bracket 26 at a position substantially aligned with lower end of the reflectors 24. The mounting ring 28 typically is used when most of the lighting fixture is concealed behind a suspended ceiling and is not required for all embodiments. Additionally, the installation bracket 26 is only one of many different arrangements for securing the lighting fixture 10 in the building.

A bridge 30 is mounted to a side of the heatsink 12 opposite the LED fixtures 22 and a junction box 32 is mounted to a side of the bridge 30 opposite the heatsink 12. An LED wire 34 extends to the junction box 32 for delivering electrical power to the LED fixtures 22. A driver box 35 is mounted in proximity to the lighting fixture 10 and is connected to a power cable 36. The driver box 35 converts the electric power into a form suitable for use by the LED fixtures 22.

Each foamed metal plate 16 in the illustrated embodiment is substantially rectangular and has opposite top and bottom ends 38 and 40 and opposite inner and outer edges 42 and 44. The bottom end 40 of each foamed metal plate 16 is bonded to the top surface 18 of the heatsink base 14. The top ends 38 of the foamed metal plates 16 define a substantially planar array that supports the bridge 30 to which the junction box 32 is mounted. The bridge 30 provides support for the foamed metal plates 16 and maintains the substantially parallel relationship between at least selected foamed metal plates 16 in the array. The outer edges 44 of the foamed metal plates define a substantially cylindrical locus with a diameter in the illustrated embodiment of approximately 7.50 inches. The foamed metal plates in the illustrated embodiment are arranged to define three arrays of parallel plates 16. The plates 16 in each array are offset from one another by approximately 120° from the plates in the other arrays. The thickness of each plate 16 and the spacing between adjacent plates 16 is selected in accordance with the heat dissipation requirements of the particular lighting fixture 10. In a typical embodiment, each fin 16 will be about 0.20 inch thick and the spacing between adjacent fins 16 typically will exceed the thickness of each fin 16. The height of each fin 16 will vary from one installation to another. However, a height of approximately 6.00-7.00 inch will be sufficient for most installations. The metal used for the heatsink 12 can vary from one installation to another. However, foamed aluminum has been found to provide desirable weight and heat dissipation characteristics, and therefore is preferred.

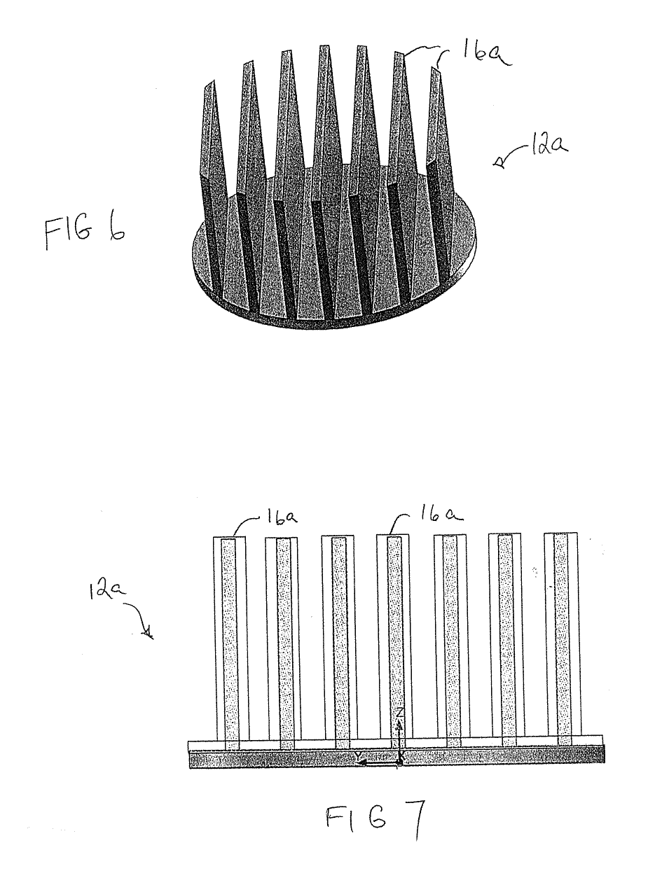

The embodiment of the invention illustrated in FIGS. 1-5 shows three arrays of parallel foamed metal plates 16. However, other arrangements of foamed metal plates can be provided. For example, FIGS. 6 and 7 show a heat sink 12a a single array of parallel fins 16a. The arrangement of fins 16a shown in FIGS. 6 and 7 provides very good air flow through the heatsink 12a and hence provides very good heat dissipation.

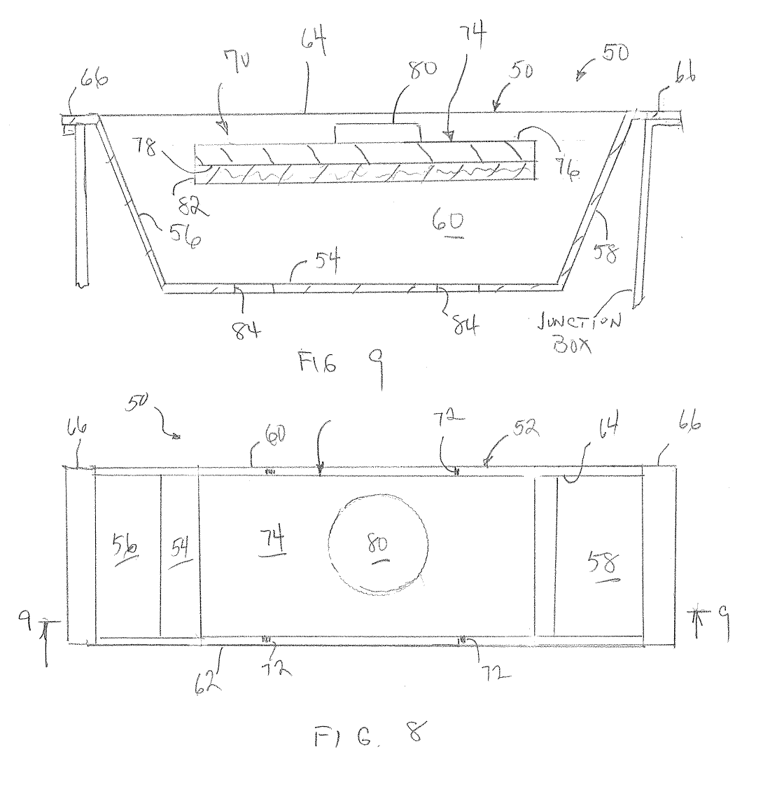

FIGS. 8 and 9 schematically illustrate a lighting fixture 50 in accordance with an alternate embodiment of the invention. The lighting fixture 50 includes a housing 52 having a rear wall 54, opposed first and second end walls 56 and 58 projecting away from the rear wall 54, and opposed first and second side walls 60 and 62 projecting from the rear wall 54 and extending between the end walls 56 and 58. The housing 50 has an open front 64 opposite the rear wall 54 and a mounting flange 66 extending out around the periphery of the open front 64. The mounting flanged 66 may be used to mount the housing 52 a junction box that accommodates wires and other electronic components for operating the lighting fixture. The rear wall 54 of the housing preferably is spaced forward from the wires and components in the junction box. At least the opposed end walls 56 and 58 are sloped to be farther from one another at greater distances from the rear wall 54. This sloped orientation facilitates a flow of cooling air as explained below. At least one opening may be formed in at least one of the walls of the housing 50 to accommodate wires and a flow of cooling air.

The lighting fixture 50 further has a light emitting assembly 70 mounted to an area of the housing 50 near the open front 64 by bridges 72. The light emitting assembly 70 includes a generally planar solid metal baseplate 74 having opposite front and rear surfaces 76 and 78 defining a thickness of about 1 cm. An LED 80 is mounted to the front surface 76 of the baseplate 74 and is oriented to emit light away from the housing 52. A foamed metal 82 is mounted to the rear surface 78 of the baseplate 74. The foamed metal 82 may be configured as described above and is at a position spaced forward from the rear wall 54 of the housing 52. Additionally, the foamed metal preferably has a thickness approximately equal to the thickness of the solid metal baseplate 74. At least opposed ends of the light emitting assembly 70 are spaced inward from the end walls 56, 58 and/or the sidewalls 60, 62 of the housing to permit a flow of cooling air into the open front 64 of the housing 52 around at least parts of the periphery of the light emitting assembly 70 and into the space between the rear wall 54 of the housing 50 and the foamed metal 82. Openings 84 can be formed through the rear wall 54, particularly in embodiments of the lighting fixture 50 that are oriented so that the rear wall 54 is gravitationally above or below the LED. In other orientations of the lighting fixture 50, at least one of the spaces between the light emitting assembly 70 and the sidewalls of the housing 52 is gravitationally above other such openings to permit an upward flow of heated air away from the light emitting assembly 70.

What is claimed is:

1. A lighting fixture, comprising:
a housing having a rear wall, sidewalls extending forward from the rear wall and an open front;
a light emitting assembly mounted to the housing at a position forward of the rear wall, the light emitting assembly including a baseplate having a front surface facing away from the rear wall of the housing and a rear surface facing toward the rear wall of the housing, at least one LED mounted to the front surface of the baseplate, and at least one foamed metal plate having a front surface mounted to the rear surface of the baseplate and a rear surface facing toward and spaced from the rear wall of the housing opposite first and second ends.

2. The lighting fixture of claim 1, wherein the baseplate is formed from a solid metal material

3. The lighting fixture of claim 2, wherein the baseplate is substantially planar.

4. The lighting fixture of claim 3, wherein the baseplate has a thickness of about 1 cm.

5. The lighting fixture of claim 4, wherein the foamed metal plate has a thickness substantially equal to the thickness of the baseplate.

6. The lighting fixture of claim 1, wherein the baseplate and the foamed metal plate have outer peripheral ages substantially registered with one another, at least two opposed edges of the baseplate and at least two opposed edges of the foamed metal plate are spaced inward from the sidewalls of the housing to define openings that communicate with a space between the foamed metal plate and the rear wall of the housing.
